(19) United States
(12) Patent Application Publication
(10) Pub. No.: US 2026/0187964 A1
(43) Pub. Date: Jul. 2, 2026

(54) IMAGE PROCESSING MODEL TRAINING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Yuqiang REN, Shenzhen (CN); Ke YAN, Shenzhen (CN)

(21) Appl. No.: 19/546,632

(22) Filed: Feb. 23, 2026

Related U.S. Application Data
(63) Continuation of application No. PCT/CN2024/107608, filed on Jul. 25, 2024.

(30) Foreign Application Priority Data
Sep. 21, 2023 (CN) 202311225352.2

(51) Int. Cl. G06V 10/25; G06T 3/4038

(52) U.S. Cl. CPC G06V 10/25; G06T 3/4038; G06T 2207/20081

(57) ABSTRACT

A image processing model training method includes acquiring training data of a model to be trained, the training data comprising a sample text, a sample image, and a sample label, and the sample label comprising detection box labels of the sample image; clustering the detection box labels to obtain N initial anchor box sizes, N being a positive integer; acquiring a text sample feature of the sample text, and detecting the sample image in combination with the N initial anchor box sizes and the text sample feature to obtain a sample detection result; and training the model to be trained based on a difference between the sample detection result and the sample label to obtain a trained image processing model, the image processing model being configured to acquire an image detection result based on an input image and an image text prompt.

### RELATED APPLICATIONS

This application is based upon and claims priority to PCT Application No. PCT/CN2024/107608, filed on Jul. 25, 2024, which claims priority to Chinese Patent Application No. 202311225352.2, filed on Sep. 21, 2023, which are incorporated herein by reference in their entirety.

### FIELD OF THE TECHNOLOGY

This application relates to an image processing technology in the field of computer vision, and in particular, to an image processing model training method and apparatus, an electronic device, a computer-readable storage medium, and a computer program product.

### BACKGROUND OF THE DISCLOSURE

When an artificial neural network model configured for executing an image processing task is trained, a sample image in training data is usually processed in a random object query manner, that is, the sample image is detected based on a random anchor box size. Accordingly, a convergence speed of the artificial neural network model is affected, and model training efficiency is further affected.

### SUMMARY

Embodiments of this application provide an image processing model training method and apparatus, an electronic device, a computer-readable storage medium, and a computer program product, which can improve model training efficiency.

Technical solutions of some embodiments of this application are implemented as follows:

An embodiment of this application provides a training method, performed by a first electronic device, the training method including acquiring training data of a model to be trained, the training data comprising a sample text, a sample image, and a sample label, and the sample label comprising detection box labels of the sample image; clustering the detection box labels to obtain N initial anchor box sizes, N being a positive integer; acquiring a text sample feature of the sample text, and detecting the sample image in combination with the N initial anchor box sizes and the text sample feature to obtain a sample detection result; and training the model to be trained based on a difference between the sample detection result and the sample label to obtain a trained image processing model, the image processing model being configured to acquire an image detection result based on an input image and an image text prompt.

An embodiment of this application further provides an image processing method, performed by a second electronic device, the image processing method including acquiring an image to be processed and an image text prompt in response to an image processing request; and detecting the image to be processed and the image text prompt by using an image processing model to obtain an image detection result, the image processing model being obtained by performing the image processing model training method provided by one embodiment of this application.

An embodiment of this application provides a first electronic device for image processing model training, the first electronic device including a first memory, configured to store a computer-executable instruction or a computer program; and a first processor, configured to implement, when executing the computer-executable instruction or the computer program stored in the first memory, the image processing method provided by one embodiment of this application.

An embodiment of this application provides a non-transitory computer-readable storage medium, having a computer-executable instruction or a computer program stored therein, the computer-executable instruction or the computer program, when being configured to be executed by a first processor, implementing the image processing model training method applied to a first electronic device provided by the embodiment of this application; or the computer-executable instruction or the computer program, when being configured to be executed by a second processor, implementing the image processing method applied to a second electronic device provided by the embodiment of this application.

Some embodiments of this application have the following beneficial effects: when the model to be trained configured to perform an image processing task is trained; the N initial anchor box sizes are determined according to a clustering result of the detection box labels; and the sample image is detected based on the N initial anchor box sizes to train the model to be trained. In the foregoing model training process, the N initial anchor box sizes are acquired by the detection box label, so that a training direction is accurately controlled. Accordingly, a convergence speed of the model is increased, and model training efficiency is improved.

### BRIEF DESCRIPTION OF THE DRAWINGS

FIG. 1 is a schematic diagram of a decoding structure according to an embodiment of this application.

FIG. 2 is a schematic diagram of another decoding structure according to an embodiment of this application.

FIG. 3 is a schematic diagram of an architecture of an image processing system in an embodiment of this application.

FIG. 4 is a schematic structural diagram of a server in FIG. 3 in an embodiment of this application.

FIG. 5 is a schematic structural diagram of a terminal in FIG. 3 in an embodiment of this application.

FIG. 6 is a schematic flowchart 1 of an image processing method in an embodiment of this application.

FIG. 7 is a schematic flowchart 2 of an image processing method in an embodiment of this application.

FIG. 8 is a schematic flowchart 3 of an image processing method in an embodiment of this application.

FIG. 9 is a diagram of a vision application architecture in an embodiment of this application.

FIG. 10 is a schematic diagram of a decoding structure in an embodiment of this application.

FIG. 11 is a schematic diagram of vision application in an embodiment of this application.

### DESCRIPTION OF EMBODIMENTS

To make the objectives, technical solutions, and advantages of this application clearer, the following describes this application in further detail with reference to the accompanying drawings. The embodiments described are not to be considered as a limitation to this application. All other embodiments acquired by a person of ordinary skill in the art without creative efforts shall fall within the protection scope of this application.

“Some embodiments” involved in the following description describes a subset of all possible embodiments. However, “some embodiments” may be same or different subsets of all the possible embodiments, and may be combined with each other when there is no conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this application described herein may be performed in an order other than that illustrated or described herein.

Unless otherwise defined, meanings of all technical and scientific terms used in this specification are the same as those usually understood by a person skilled in the art. Terms used in some embodiments of this application are merely intended to describe objectives of some embodiments of this application, but are not intended to limit this application.

Before some embodiments of this application are further described in detail, a description is made on nouns and terms in some embodiments of this application, and the nouns and terms in some embodiments of this application are applicable to the following explanations.
1) An artificial neural network is a mathematics model mimicking a structure and a function of a biological neural network. A structure of the artificial neural network in one embodiment of this application includes a graph convolutional network (GCN, a neural network configured to process graph structure), a deep neural network (DNN), a convolutional neural network (CNN), a recurrent neural network (RNN), a neural state machine (NSM), a phase-functional neural network (PFNN), and the like. A model to be trained and an image processing model involved in embodiments of this application are both artificial neural network models.
2) Known classes refer to classes to which an object already labeled in training data belongs; a class corresponding to a third object score in an embodiment of this application may include a known class.
3) Unknown classes refer to classes to which an object exists in test data and to-be-tested data but does not exist in the training data; a class corresponding to the third object score in one embodiment of this application may include an unknown class.
4) Object detection is processing of specifying each object in an image and determining a class (including a known class and an unknown class) of the object; image processing in one embodiment of this application includes object detection.
5) Open set object detection refers to performing object detection on the test data of an open set; in this case, not only a position and a class of the object of the known class can be determined, but also a position of the object of the unknown class can be determined. According to one embodiment of this application, a process of training the model to be trained may include open set object detection.
6) A features pyramid network (FPN) is configured to form a backbone with a Resnet to extract a multi-scale feature of an image.
7) Unknown probability refers to a probability that a detected object belongs to an unknown class, and is also referred to as a score of the unknown class.
8) A feature map refers to a feature acquired after convolution is performed on an image and a filter; the feature map may further continue to be convolved with the filter to obtain a new feature map, for example, an initial image feature in an embodiment of this application.
9) A latent space refers to a feature space formed by network latent features (an output of a network intermediate layer), for example, a feature space in each encoder and decoder in an embodiment of this application.
10) A latent region refers to a region in the latent space.
11) A region feature refers to a depth feature acquired after information passes through a fully connected layer, and is configured for performing object detection.
12) An encoding vector is a feature vector acquired by performing size reduction on a region feature by using a plurality of fully-connected layers, for example, a 1024-dimensional region feature is dimensionally reduced to a 128-dimensional encoded vector.

In the computer vision field, for example, in numeral classification, an artificial neural network model uses an image as an input and generates 10 outputs, and each output represents a probability of one of numeral classes. Therefore, there is a task commonality problem. To improve universality, more tasks may continue to be added to the foregoing artificial neural network model, for example, a new prediction type and a new data set are added. In this case, an architecture is usually extended by adding additional output heads. For example, when ImageNet classification and Coco detection are performed, confidence output heads of 1000 classes, detection boxes of 80 classes, and corresponding confidence output heads are included. Accordingly, a quantity of output heads increases as tasks and data sets increase. Accordingly, model training efficiency is affected. In addition, detection boxes of 1000 confidence types and 80 classes are always generated each time model application affects image detection efficiency.

To improve model training efficiency and image detection efficiency, a task may further be defined by using a natural language text, to replace multi-headed output. For example, a visual question answering (VQA) task: “What is sitting on a sofa?”, an object detection and locating task: “Find all instances of dogs”, an image description task: “What happens in the image”, and an image classification task: “What type of object is this?”. However, in a multi-tasking visual system using natural language texts, although computer vision tasks (such as visual question answering, image description, image classification, and object detection and locating) can be performed, the multi-tasking visual system relies on a pre-trained model of a visual language, for example, relies on pre-trained end-to-end object detection with transformers (DETR). Object query used by the DETR has no clear physical meaning, affecting convergence of model training, and further affecting model training efficiency.

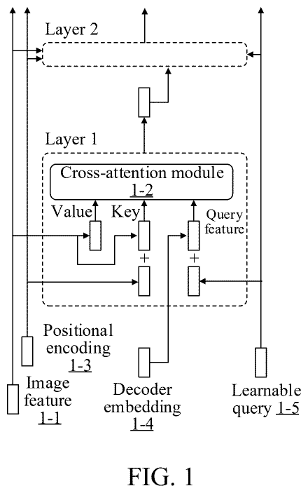

For example, FIG. 1 is a schematic diagram of a decoding structure according to an embodiment of this application. As shown in FIG. 1, an image feature 1-1 is taken as a value (V, also referred to as a value feature) to be inputted into a cross-attention module 1-2 of each layer (layer 1 is exemplarily shown), a positional encoding 1-3 and the image feature 1-1 are taken as keys (K, also referred to as a key feature) to be inputted into the cross-attention module 1-2 of each layer, and an initialized decoder embedding 1-4 and a learnable query 1-5 are taken as query features (Q1) to be inputted into the cross-attention module 1-2 of each layer. Further, processing on the next layer (for example, layer 2) is performed in combination with an output of the cross-attention module 1-2.

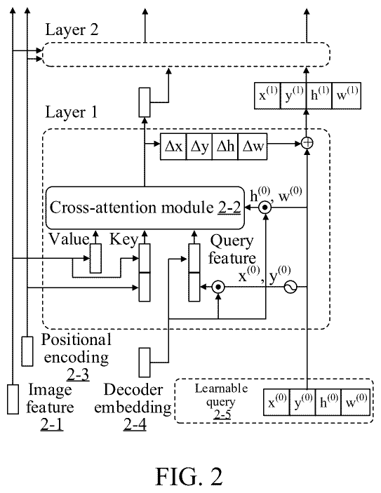

In addition, the learnable query may alternatively be set to a random anchor box. For example, FIG. 2 is a schematic diagram of another decoding structure according to an exemplary embodiment of this application. As shown in FIG. 2, an image feature 2-1 is taken as a value to be inputted into a cross-attention module 2-2 of each layer (layer 1 is exemplarily shown), a positional encoding 2-3 and the image feature 2-1 are taken as keys to be inputted into a cross-attention module 2-2 of each layer, and an initialized decoder embedding 2-4 and a learnable query 2-5 (x⁽⁰⁾, y⁽⁰⁾, h₍₀₎, w₍₀₎) are taken as query features to be inputted into the cross-attention module 2-2 of each layer. Further, processing on the next layer (for example, layer 2) is performed in combination with an output of the cross-attention module 2-2. For example, an offset (Δx, Δy, Δh, Δw) outputted by layer 1 is configured to be superimposed with (x⁽⁰⁾, y⁽⁰⁾, h₍₀₎, w₍₀₎) to obtain an object query of layer 2 (x₍₁₎, y₍₁₎, h₍₁₎, w₍₁₎). Specifically, (x⁽⁰⁾, y⁽⁰⁾, h₍₀₎, w₍₀₎) in (x⁽⁰⁾, y₍₀₎) is taken as a position query; (h₍₀₎, w₍₀₎) is configured to adjust the cross-attention model 2-2.

A dynamic anchor box end-to-end object detection with transformers (DAB-DETR) in FIG. 2 provides an object query using dynamic anchor boxes (DAB), and performs updating layer by layer. Accordingly, an explicit position prior can be used to improve a similarity between object query and features, so that a model convergence speed is improved. In addition, using the length and the width of the anchor box in the attention image corresponding to the position is equivalent to continuously adjusting the object query by using layer-by-layer Soft RoI Pooling. However, a problem of model convergence efficiency still exists.

Based on this, embodiments of this application provide an image processing method and apparatus, an electronic device, a computer-readable storage medium, and a computer program product. The following describes an embodiment of a device provided in some embodiments of this application. Both a first electronic device for image processing model training provided by the of this application (hereinafter referred to as model training device), and a second electronic device for image processing (hereinafter referred to as model application device) may be implemented as various types of terminals such as a smartphone, a smart watch, a laptop computer, a tablet computer, a desktop computer, an intelligent household appliance, a set-top box, an intelligent on-board device, a portable music player, a personal digital assistant, a dedicated messaging device, an intelligent voice interaction device, a portable gaming device, and an intelligent speaker, or may be implemented as a server, or a combination of both. The following describes an embodiment in which the model training device is implemented as a server, and the model application device is implemented as a terminal.

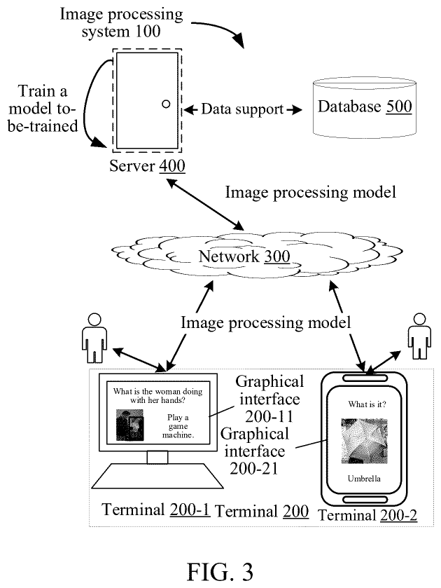

FIG. 3 is a schematic diagram of an architecture of an image processing system provided by an embodiment of this application. As shown in FIG. 3, to support an image processing application, in an image processing system 100, terminals 200 (a terminal 200-1 and a terminal 200-2 are exemplarily shown) are connected to a server 400 through a network 300. The network 300 may be a wide area network, a local area network, or a combination thereof. In addition, the image processing system 100 further includes a database 500, configured to provide data support for the server 400. In addition, FIG. 3 shows a case in which the database 500 is independent of the server 400. In addition, the database 500 may be integrated into the server 400. This is not limited in one embodiment of this application.

The terminal 200 is configured to acquire an image to be processed and an image text prompt in response to an image processing request. The image to be processed and the image text prompt are detected by using an image processing model to obtain an image detection result. The image processing model is transmitted by the server 400 via the network 300, and displays the image to be processed, the image text prompt, and the image detection result (exemplarily, a graphical interface 200-11 and a graphical interface 200-21 are shown).

The server 400 is configured to acquire training data of a model to be trained, the training data including sample text, a sample image, and a sample label, and the sample label including detection box labels of the sample image; cluster the detection box labels to obtain N initial anchor box sizes; and perform the following process to train the model: detecting the sample image in combination with the N initial anchor box sizes and the text sample feature of the sample text to obtain a sample detection result; training the model to be trained based on a difference between the sample detection result and the sample label to obtain an image processing model; and transmitting the image processing model to the terminal 200 via the network 300.

In some embodiments, the server 400 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal and the server may be connected directly or indirectly in a wired or wireless communication protocol. The connection manner is not limited in some embodiments of this application.

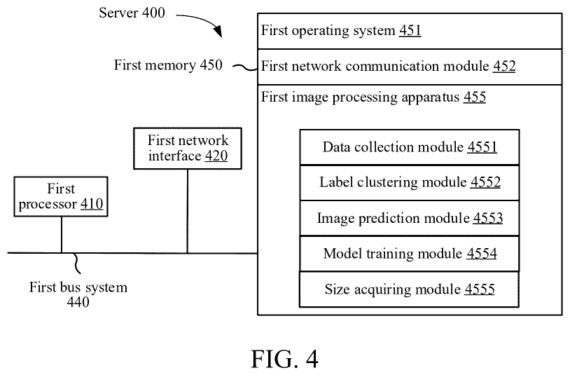

FIG. 4 is a schematic structural diagram of a server in FIG. 3 provided by an embodiment of this application; as shown in FIG. 4, the server 400 includes: at least a first processor 410, a first memory 450, and at least a first network interface 420. Components in the server 400 are coupled together through a first bus system 440. The first bus system 440 is configured to implement connection and communication between these components. In addition to a data bus, the first bus system 440 also includes a power supply bus, a control bus, and a status signal bus. However, for ease of clear description, all types of buses are marked as the first bus system 440 in FIG. 4.

The first processor 410 may be an integrated circuit chip with a signal processing capability, such as a general-purpose processor, a digital signal processor (DSP), or another programmable logic device (PLD), discrete gate, transistor logic device, or discrete hardware component. The general-purpose processor may be a microprocessor, any conventional processor, or the like.

The first memory 450 may be a removable memory, an irremovable memory, or a combination of the two. In embodiments of the present application, hardware devices include a solid memory, a hard disk drive, an optical disk drive, and the like. In an embodiment, the first memory 450 includes one or more storage devices that are physically located away from the first processor 410.

The first memory 450 includes a volatile memory or a non-volatile memory, or may include both a volatile memory and a non-volatile memory. The non-volatile memory may be a read-only memory (ROM), and the volatile memory may be a random access memory (RAM). The first memory 450 described in some embodiments of this application aim to include any suitable type of memories.

In some embodiments, the first memory 450 can store data to support various operations. Examples of the data include a program, a module, or a data structure or a subset or a superset thereof, which are exemplarily described below.

A first operating system 451 includes system programs configured to process various basic system services and execute hardware-related tasks, for example, a framework layer, a core library layer, and a driver layer, for implementing various basic services and processing hardware-based tasks.

A first network communication module 452 is configured to reach another electronic device through one or more (wired or wireless) first network interfaces 420. In embodiments of the present application, first network interfaces 420 include: Bluetooth, wireless fidelity (Wi-Fi), a universal serial bus (USB), and the like.

In some embodiments, a first image processing apparatus provided in some embodiments of this application may be implemented by software. FIG. 4 shows a first image processing apparatus 455 stored in the first memory 450, which may be software in a form of a program and a plug-in, and includes the following software modules: a data collection module 4551, a label clustering module 4552, an image prediction module 4553, a model training module 4554, and a size acquiring module 4555. The modules are logical and may be combined in different manners or further split based on to-be-implemented functions. Functions of the modules are described below.

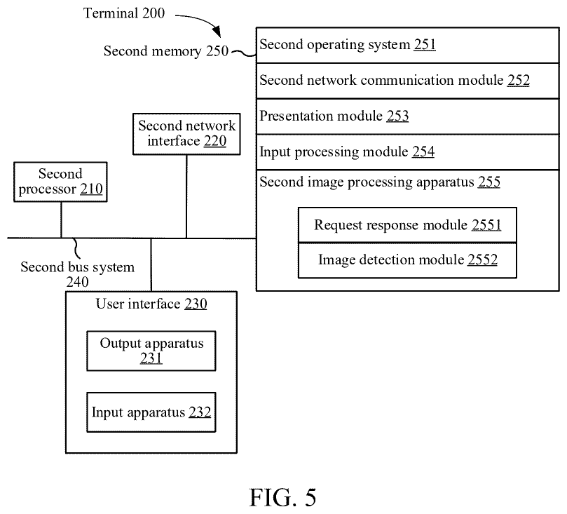

FIG. 5 is a schematic structural diagram of a terminal in FIG. 3 provided by an embodiment of this application; as shown in FIG. 5, the terminal 200 includes: at least a second processor 210, a second memory 250, at least a second network interface 220, and a user interface 230. Components in the terminal 200 are coupled together by using a second bus system 240. The second bus system 240 is configured to implement connection and communication among the components. In addition to a data bus, the second bus system 240 also includes a power supply bus, a control bus, and a status signal bus. However, for ease of clear description, all types of buses are marked as the second bus system 240 in FIG. 5.

The second processor 210 may be an integrated circuit chip with a signal processing capability, such as a general-purpose processor, a digital signal processor, or another programmable logic device (PLD), discrete gate, transistor logic device, or discrete hardware component. The general-purpose processor may be a microprocessor, any conventional processor, or the like.

The user interface 230 includes one or more output apparatuses 231 that facilitate the presentation of media content, including one or more speakers and/or one or more visual displays. The user interface 230 further includes one or more input apparatuses 232, including user interface components that facilitate user input, such as a keyboard, a mouse, a microphone, a touchscreen display, a camera, and other input buttons and controls.

The second memory 250 may be a removable memory, an irremovable memory, or a combination of the two. In embodiments of the present application, hardware devices include a solid memory, a hard disk drive, an optical disk drive, and the like. In an embodiment, the second memory 250 includes one or more storage devices that are physically located away from the second processor 210.

The second memory 250 includes a volatile memory or a non-volatile memory, or may include both a volatile memory and a non-volatile memory. The non-volatile memory may be a read-only memory, and the volatile memory may be a random access memory. The second memory 250 described in some embodiments of this application aim to include any suitable type of memories.

In some embodiments, the second memory 250 can store data to support various operations. Examples of the data include a program, a module, or a data structure or a subset or a superset thereof, which are exemplarily described below.

A second operating system 251 includes system programs configured to process various basic system services and execute hardware-related tasks, for example, a framework layer, a core library layer, and a driver layer, for implementing various basic services and processing hardware-based tasks.

A second network communication module 252 is configured to reach another electronic device through one or more (wired or wireless) second network interfaces 220. In embodiments of the present application, second network interfaces 220 include: Bluetooth, wireless fidelity, a universal serial bus, and the like.

A presentation module 253 is configured to enable the presentation of information (for example, a user interface for operating peripheral devices and displaying content and information) through one or more output apparatuses 231 (for example, display screens or speakers) associated with the user interface 230.

An input processing module 254 is configured to detect one or more user inputs or interactions from one or more input apparatuses 232 and translate the detected inputs or interactions.

In some embodiments, a second image processing apparatus provided in some embodiments of this application may be implemented by software. FIG. 3 shows a second image processing apparatus 255 stored in the second memory 250, which may be software in a form of a program and a plug-in, and includes the following software modules: a request response module 2551, and an image detection module 2552. The modules are logical and may be combined in different manners or further split based on to-be-implemented functions. Functions of the modules are described below.

In some embodiments, the first image processing apparatus and the second image processing apparatus provided by some embodiments of this application may be implemented in hardware. As an example, the first image processing apparatus and the second image processing apparatus provided by some embodiments of this application may be processors in the form of a hardware decoding processor, programmed to perform the processor processing method provided by some embodiments of this application. For example, the processor in the form of a hardware decoding processor may use one or more application specific integrated circuits (ASIC), a DSP, a programmable logic device (PLD), a complex programmable logic device (CPLD), a field-programmable gate array (FPGA), or other electronic components.

In some embodiments, the terminal may implement the image processing method provided by some embodiments of this application by running various computer-executable instructions or computer programs. For example, the computer-executable instruction may be a microprogram-level command, a machine instruction, or a software instruction. The computer program may be a native program or a software module in an operating system; it may be a native application (APP), namely, a program that needs to be installed in an operating system to run, for example, an image APP; or it may be a mini program that may be embedded in any APP, namely, a program that only needs to be downloaded into a browser environment to run. To sum up, the computer-executable instruction may be an instruction in any form, and the foregoing computer program may be an application, a module, or a plug-in in any form.

The image processing method provided by some embodiments of this application is described below in combination with the embodiments and implementations of the model training device and the model application device provided by some embodiments of this application. In addition, the image processing method provided by some embodiments of this application is applicable to various image processing scenarios such as cloud technologies, artificial intelligence, intelligent traffic, on-board application, and maps.

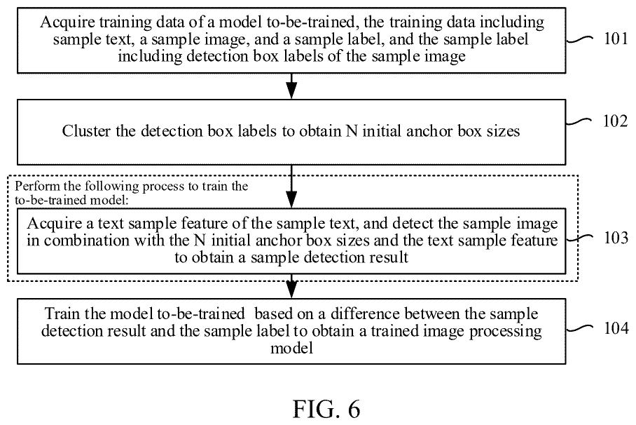

FIG. 6 is a schematic flowchart 1 of an image processing method provided by an embodiment of this application. An execution body of operations is the model training device. Descriptions are provided in combination with operations shown in FIG. 6.

Operation 101: Acquire training data of a model to be trained, the training data including sample text, a sample image, and a sample label, and the sample label including detection box labels of the sample image.

In one embodiment of this application, the model training device acquires a data set for training the model to be trained; and the acquired data set for training the model to be trained is named as the training data.

The sample image is an image on which image processing is to be performed in the training data, for example, an image to be classified, an image to be described, an image on which object detection is to be performed, or an image on which question answering is to be performed. The sample text is a text prompt of the sample image, and is configured to determine a processing direction and a processing result of an image processing task. For example, in a visual question answering scenario, the sample text may be prompt text for querying an image on which question answering is to be performed. In an image description scenario, the sample text may be prompt text instructing to describe a to-be-described image. In an object detection and locating scenario, the sample text may be prompt text instructing to perform object detection on an image on which object detection is to be performed. In an image classification scenario, the sample text may be prompt text instructing to classify an image to be classified. Herein, the sample image and the sample text are jointly combined as input data of an artificial neural network model. The sample label is labeled data of the sample image and the sample text, is a real image processing result, and includes at least one of the following: the detection box labels of the sample image, a text output result label, a class label, and the like. In addition, the model to be trained is a artificial neural network model to be trained, and the model to be trained is configured for image processing. Herein, the model to be trained may be an original constructed artificial neural network model, or may be a pre-trained artificial neural network model. This is not limited in one embodiment of this application.

The image processing described in one embodiment of this application refers to processing of detecting an image in combination with text, so as to acquire detected content matching the text description. The image processing includes at least one of the following: visual question answering, image description, object detection and locating, and image classification.

Operation 102: Cluster the detection box labels to obtain N initial anchor box sizes.

The model training device clusters the detection box labels to cluster detection boxes of a same size into one class. N detection box sizes are determined based on various clustering results, to be taken as the N initial anchor box sizes.

In one embodiment of this application, the model training device clusters the detection box labels based on a size dimension to obtain a plurality of detection box size classes through clustering, determines a detection box size based on each detection box size class to obtain M detection box sizes, and selects N detection box sizes from the M detection box sizes as the N initial anchor box sizes. N is a positive integer, M≥N, and M is an integer.

The initial anchor box size is a size of a region in which the preset query object is located. The query object is an entity existing in the preset sample image, for example, an animal, a person, an object, or a scenario in the sample image.

In operation 102 of one embodiment of this application, that the model training device clusters the detection box labels to obtain the N initial anchor box sizes includes: clustering, by the model training device, the detection box labels based on the size dimension to obtain M classes of clustering results (referred to as M detection box size classes); acquiring the M detection box sizes corresponding to the M classes of clustering results; and next, collecting statistics on a quantity of detection boxes of each detection box size from the detection box labels; finally, selecting, from M detection box sizes, N detection box sizes with a largest quantity of detection boxes; and determining the N initial anchor box sizes based on the N detection box sizes.

When the model training device clusters the detection box labels, the model training device performs clustering according to the size dimension to obtain M class clusters; and the M class clusters are M clustering results. In one clustering result, sizes of detection boxes are similar; and a size difference between two detection boxes belonging to different clustering results is greater than a difference threshold. Herein, the model training device determines, for the sizes respectively corresponding to the detection boxes in each clustering result, a detection box size representing the clustering result. For determining the detection box size, the model training device may determine the size by selecting a detection box, or may determine the size by acquiring an average size of each detection box in the clustering result. This is not limited in one embodiment of this application. Finally, the model training device can acquire the M detection box sizes for the M classes of clustering results. In addition, the model training device may determine each of the M detection box sizes as the initial anchor box size, or may determine some detection box sizes selected from the M detection box sizes as the N initial anchor box sizes. This is not limited in one embodiment of this application. When determining part of detection box sizes selected from the M detection box sizes as the N initial anchor box sizes, the model training device performs selection based on the quantity of detection boxes. The quantity of detection boxes refers to a quantity of detection boxes that are in the detection box labels and whose size is the detection box size.

In one embodiment of this application, the model training device performs the following process to train the model to be trained (operation 103) to obtain a result of performing image processing on the sample text and the sample image based on the model to be trained.

Operation 103: Acquire a text sample feature of the sample text, and detect the sample image in combination with the N initial anchor box sizes and the text sample feature to obtain a sample detection result.

In one embodiment of this application, the model training device may extract a feature of the sample text by using the model to be trained, and the extracted feature is named as a text sample feature. Next, the model training device determines each object query box corresponding to each position point based on the N initial anchor box sizes, and finally, can acquire a plurality of object query boxes for the sample image. Next, a feature configured for object detection is determined by using a plurality of object query boxes; object detection is performed based on the determined feature configured for object detection; and image processing matching content described by the sample text is performed in combination with the determined feature configured for object detection and the text sample feature, so as to obtain the sample detection result.

The sample detection result is a result of performing image processing on the sample text and the sample image based on the model to be trained.

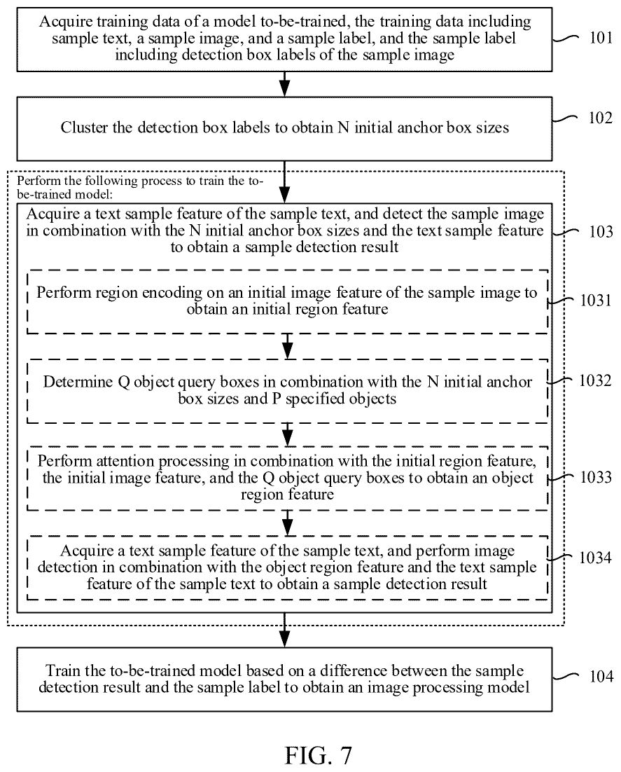

FIG. 7 is a schematic flowchart 2 of an image processing method provided by an embodiment of this application. An execution body of operations is the model training device. As shown in FIG. 7, in one embodiment of this application, operation 103 may be implemented through operation 1031 to operation 1034. That is, the model training device acquires the text sample feature of the sample text, detects the sample image in combination with the N initial anchor box sizes and the text sample feature to obtain the sample detection result, including operation 1031 to operation 1034. The following describes each operation.

Operation 1031: Perform region encoding on an initial image feature of the sample image to obtain an initial region feature.

In one embodiment of this application, the model training device may extract a feature of a whole dimension of the sample image based on the model to be trained, and the extracted feature is named as an initial image feature. Next, the model training device performs region encoding on the initial image feature to optimize the initial image feature. The region encoding is configured for converting the initial image feature into a spatial feature in a local region position dimension of the sample image. Herein, the region encoding result is named as an initial region feature.

The initial image feature is a space feature of a whole dimension of the sample image, and is a basic feature representation configured for performing image processing on the sample image.

Operation 1032: Determine Q object query boxes in combination with the N initial anchor box sizes and P specified objects.

In one embodiment of this application, the model training device can acquire the P specified objects; each specified object corresponds to a preset object, and the plurality of specified objects are objects that are preset for the sample image and that are at most included in the sample image. Herein, the model training device determines the object query boxes of the N initial anchor box sizes for each specified object, and finally, for the P specified objects, can acquire P*N object query boxes. Therefore, Q=P*N.

Each specified object is a preset position in the sample image; the model training device determines a region box by using the specified object as a center and each initial anchor box size as a size; and the determined region box is the object query box. Therefore, for the N initial anchor box sizes and P specified objects, P*N object query boxes can be acquired.

In one embodiment of this application, the object query box includes the following information: an anchor point and an anchor box, the anchor point indicating a position point of the specified object in the sample image, and the anchor box indicating a region box size using the anchor point as a center.

Operation 1033: Perform attention processing in combination with the initial region feature, the initial image feature, and the Q object query boxes to obtain an object region feature.

In one embodiment of this application, the model training device may acquire a feature of each object query box through initialization, combine the object query box and the feature of the object query box into a query feature, and compare similarities between the query feature and the initial region feature and the initial image feature to implement attention processing on the initial region feature, the initial image feature, and the Q object query boxes, so as to detect an object that corresponds to the object query box and that is similar to the feature of the object query box. The feature configured for representing the object is an object region feature.

In one embodiment of this application, the performing, by the model training device, attention processing in combination with the initial region feature, the initial image feature, and the Q object query boxes to obtain an object region feature includes: determining, by the model training device, a key feature, a value feature, and a query feature in combination with the initial region feature, the initial image feature, and the Q object query boxes; performing attention processing on the key feature, the value feature, and the query feature by using an object decoder of the model to be trained to obtain Q query box offsets; and correspondingly superimposing the Q query box offsets onto the Q object query boxes to obtain Q object anchor boxes; and acquiring features respectively corresponding to the Q object anchor boxes to obtain the object region feature. The object decoder is a decoder that is in the model to be trained and that is configured to acquire the object region feature in combination with the key feature, the value feature, and the query feature. The object decoder has one layer. Certainly, there may be a plurality of layers of the object decoder.

In one embodiment of this application, the determining a key feature, a value feature, and a query feature in combination with the initial region feature, the initial image feature, and the Q object query boxes includes: determining, by the model training device, the key feature based on the initial region feature and the initial image feature; determining the value feature based on the initial image feature; and determining the query feature based on the Q object query boxes and the specified content features respectively corresponding to the Q object query boxes.

Attention processing performed by the model training device on the initial region feature, the initial image feature, and the Q object query boxes is a cross-attention-based decoding process. The initial region feature and the initial image feature are configured to determine the key feature; the initial image feature is configured to determine the value feature; and the object query box and a feature (referred to as a specified content feature) of the initialized object query box are configured to determine the query feature, so as to further perform attention processing on the value feature, the key feature, and the query feature. Herein, attention processing results corresponding to the initial region feature, the initial image feature, and the Q object query boxes are Q query box offsets; and the Q query box offsets are in a one-to-one correspondence with the Q object query boxes. Therefore, the model training device superimposes the Q query box offsets and the Q object query boxes in a one-to-one correspondence, to complete processing of superimposing the corresponding query box offset on each object query box. A superimposition result of each object query box and the corresponding query box offset is one object anchor box, so that Q object anchor boxes corresponding to the Q object query boxes can be acquired. In addition, the object region feature includes a feature corresponding to each of the plurality of object anchor boxes.

Operation 1034: Acquire a text sample feature of the sample text, and perform image detection in combination with the object region feature and the text sample feature of the sample text to obtain a sample detection result.

In one embodiment of this application, the model training device can implement object detection on the sample image based on the object region feature. Then, a text sample feature of the sample text is acquired. In combination with the object detection result and the text sample feature, an image processing result, that is, a sample detection result, corresponding to the sample image and the sample text can be acquired.

In one embodiment of this application, the performing, by the model training device, image detection in combination with the object region feature and the text sample feature to obtain a sample detection result includes: first performing, by the model training device, detection box prediction based on the object region feature to obtain a predicted detection box; then performing attention processing on the object region feature and the text sample feature of the sample text to obtain an associated feature; predicting a first object score of the predicted detection box based on the object region feature; predicting a second object score of the predicted detection box based on the associated feature; obtaining a third object score in combination with the first object score and the second object score; obtaining a text prediction result in combination with the third object score and the associated feature; and finally, determining the sample detection result based on the text prediction result.

The object region feature refers to a feature for performing object detection, so that the model training device can predict, by using a detection box head in the model to be trained, a detection box in which an object corresponding to the object region feature is located, which is named as the predicted detection box. Because the image processing task is defined by the sample text, the model training device performs attention processing on the object region feature based on the text sample feature, to extract, from the object region feature, a feature associated with the sample text, that is, the associated feature. In addition, the model training device predicts a class score of each predicted detection box based on the object region feature by using an objectness head in the model to be trained, that is, the first object score is acquired. The first object score is a score unrelated to the image processing task defined by the sample text. The model training device further predicts, by using a relatedness head in the model to be trained and based on the associated feature, a score of a predicted detection box associated with the image processing task to obtain the second object score. The second object score is a score related to the image processing task defined by the sample text. Next, the model training device performs weighted fusion on the first object score and the second object score to obtain the third object score. The third object score is a final score related to the image processing task defined by the sample text. The third object score represents a score of the to-be-processed object in the image processing task. Therefore, the model training device predicts the third object score and the associated feature by using a text output head of the model to be trained to obtain the text prediction result. The text prediction result is configured for describing an image processing result of the sample image.

The sample detection result includes at least a text prediction result. In scenarios such as visual question answering, image description, and object detection and locating, a sample detection result includes a text prediction result and a sample image carrying a detection box; and the carried detection box is a detection box of a target object corresponding to the sample text. That is, the determining, by the model training device, the sample detection result based on the text prediction result includes: determining, by the model training device, a to-be-carried detection box in the predicted detection boxes based on the third object score; acquiring, in combination with the to-be-carried detection box and the sample image, the sample image carrying the detection box; and determining the text prediction result and the sample image carrying the detection box as the sample detection result. In a scenario such as image classification, a sample detection result includes a text prediction result. That is, the determining, by the model training device, the sample detection result based on the text prediction result includes: determining, by the model training device, the text prediction result as the sample detection result.

In one embodiment of this application, the performing, by the model training device, attention processing on the object region feature and the text sample feature to obtain an associated feature includes: performing, by the model training device, linear conversion on the object region feature to obtain an image linear feature; performing linear conversion on the text sample feature to obtain a text linear feature; then, performing attention processing on the image linear feature and the text linear feature to obtain a relatedness weight; and finally, superimposing the relatedness weight and the image linear feature to obtain the associated feature.

The model training device performs linear conversion on the object region feature, and performs linear conversion on the text sample feature, so that the object region feature after the linear conversion and the text sample after the linear conversion are dimensionally consistent. The image linear feature is an object region feature after linear conversion; and the text linear feature is a text sample after linear conversion. Herein, the model training device performs attention processing on the image linear feature and the text linear feature to obtain, from the image linear feature, a feature corresponding to the sample text, that is, the associated feature.

In one embodiment of this application, the performing, by the model training device, attention processing on the object region feature and the text sample feature to obtain the associated feature includes: pooling, by the model training device, an initial image feature based on the predicted detection box to obtain an object image feature; acquiring a stitching feature of the object image feature and the object region feature; and finally, performing attention processing on the stitching feature and the text sample feature of the sample text to obtain the associated feature.

The model training device is further configured to apply the predicted detection box to the initial image feature to improve accuracy of the initial image feature. In addition, because the object image feature is a feature in a whole dimension of the sample image, richness and comprehensiveness of the stitching feature can be improved by stitching the object image feature and the object region feature. Further, image processing is performed based on the stitching feature to obtain the sample detection result, so that accuracy of image processing is improved.

In operation 103 of one embodiment of this application, the detecting, by the model training device, the sample image in combination with the N initial anchor box sizes and the text sample feature to obtain a sample detection result includes: detecting, by the model training device, the sample image in combination with the L specified anchor box sizes, the N initial anchor box sizes, and the text sample feature to obtain the sample detection result.

After the N initial anchor box sizes are obtained by clustering the detection box labels, the model training device can acquire the L specified anchor box sizes different from the N initial anchor box sizes, where L is a positive integer. Therefore, the model training device can determine the object query box in combination with the L specified anchor box sizes and the N initial anchor box sizes.

The model training device acquires the L specified anchor box sizes different from the N initial anchor box sizes to improve diversity of the anchor box sizes, so that accuracy of image detection is improved.

Operation 104: Train the model to be trained based on a difference between the sample detection result and the sample label to obtain an image processing model.

In one embodiment of this application, after acquiring the sample detection result, the model training device compares the sample detection result with the sample label to obtain a difference between the sample detection result and the sample label. Because the difference between the sample detection result and the sample label represents accuracy of the model to be trained, the model training device calculates a loss function value based on the difference between the sample detection result and the sample label, and performs back propagation in the model to be trained based on the loss function value, to adjust a model parameter of the model to be trained. In addition, training of the model to be trained is performed iteratively. When the iterative training ends, the model to be trained acquired through current iterative training is the image processing model. The image processing model is configured to acquire an image detection result based on an input image and an image text prompt.

When determining that the iterative training satisfies a training ending condition, the model training device determines that the iterative training ends. Otherwise, the iterative training continues to be performed. The training ending condition may be that an accuracy indicator threshold is reached; an iteration quantity threshold is reached; an iteration duration threshold is reached; a combination thereof is reached, or the like. This is not limited in one embodiment of this application.

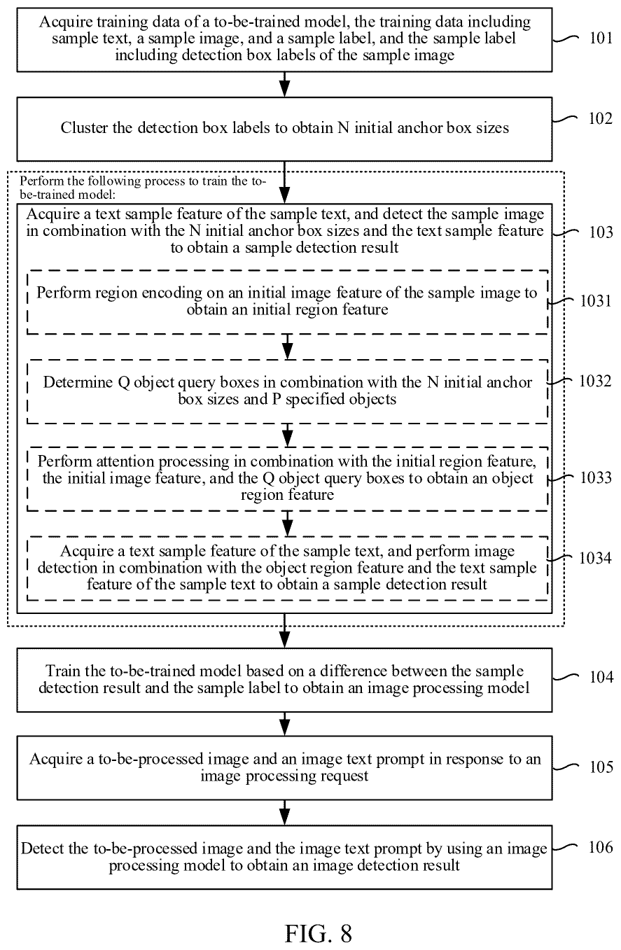

FIG. 8 is a schematic flowchart 3 of an image processing method provided by an embodiment of this application. An execution body of operations is the model application device. Descriptions are provided in combination with operations shown in FIG. 8.

Operation 105: Acquire an image to be processed and an image text prompt in response to an image processing request.

In some embodiments of this application, the model application device acquires the image processing model from the model training device and deploys the image processing model on the model application device. Then, when receiving the image processing request, the model application device may perform image processing by using the deployed image processing model.

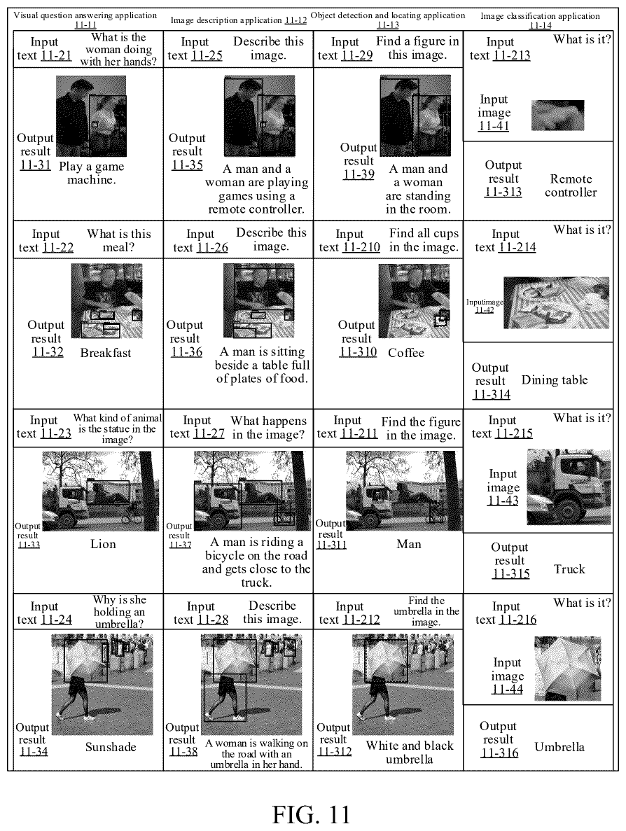

The image processing request is configured for requesting to perform, on the image to be processed, an image processing task indicated by the image text prompt. Therefore, the model application device can acquire the image to be processed and the image text prompt by using the image processing request. The image to be processed is an image on which image visual processing is to be performed; and the image text prompt is configured for describing a visual processing task of the image to be processed. In addition, in a visual question answering scenario, the image text prompt may be prompt text for question asking about the image to be processed, for example, input text 11-21 to input text 11-24 in FIG. 11. In an image description scenario, the image text prompt may be prompt text instructing to describe the image to be processed, for example, input text 11-25 to input text 11-28 in FIG. 11. In an object detection and locating scenario, the image text prompt may be prompt text instructing to perform object detection on the image to be processed, for example, input text 11-29 to input text 11-212 in FIG. 11. In an image classification scenario, the image text prompt may be prompt text instructing to classify the image to be processed, for example, input text 11-213 to input text 11-216 in FIG. 11.

Operation 106: Detect the image to be processed and the image text prompt by using an image processing model to obtain an image detection result.

The image detection result is an output result acquired by performing, by the model application device, image visual processing on the image to be processed and the image text prompt by using the image processing model. The image processing model is acquired by an image training device by performing training using training data. The image text prompt is prompt text of any one of the following image processing tasks: visual question answering, image description, object detection and locating, and image classification.

In some embodiments of this application, the model training device may be various servers; the model application device may be various servers or various terminals; and the model training device and the model application device may be a same device, or the like. This is not limited in some embodiments of this application.

Next, an embodiment of this application in an application scenario is to be described. The embodiment describes a process of determining the anchor box based on the clustering result of the detection box labels to improve model training efficiency.

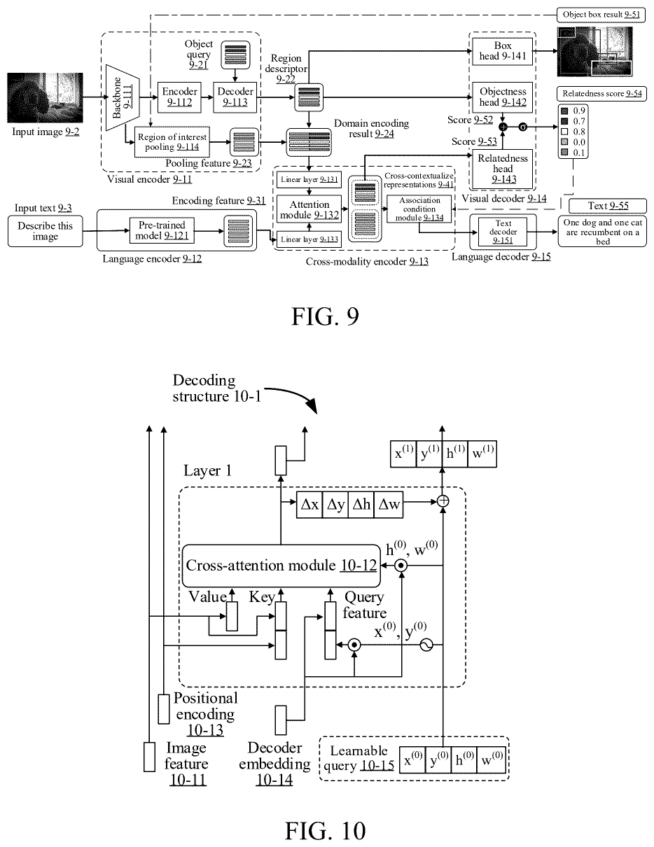

FIG. 9 is a diagram of a vision application architecture provided by an embodiment of this application. As shown in FIG. 9, the architecture includes a visual encoder 9-11, a language encoder 9-12, a cross-modality encoder 9-13, a visual decoder 9-14 (that is, an output head of a box and a score), and a language decoder 9-15 (that is, an output head of text, which is a Transformer decoder). The following separately describes the modules.

The visual encoder 9-11 uses a backbone 9-111 of a CNN, an anchor-DETR encoder 9-112 and an anchor-DETR decoder 9-113 of an anchor-DETR, and region of interest (RoI) pooling 9-114.

The language encoder 9-12 performs encoding by using a pre-trained model 9-121 (BERT).

The cross-modality encoder 9-13 includes a linear layer 9-131 and an attention module 9-132 (attention module of a multi-modality pre-trained model ViLBERT), a linear layer 9-133, and an association condition module 9-134. The attention module 9-132 can perform cross-contextualize representations on expressions of the visual encoder and the language encoder.

The visual decoder 9-14 includes a box head 9-141, an objectness head 9-142, and a relatedness head 9-143 (referred to as an associated score output head).

The language decoder 9-15 includes a text decoder 9-151.

For an input image 9-2 (referred to as a sample image), the backbone 9-111 extracts a convolutional feature (referred to as an initial image feature), and takes the extracted feature as input of the encoder 9-112 and the region of interest pooling 9-114. The encoder 9-112 is configured to process the input feature to obtain a context feature (referred to as an initial region feature) of each grid position, and take the context feature and an object query 9-21 (referred to as an object query box) as input of the decoder 9-113, so as to generate a corresponding region descriptor 9-22 (referred to as an object region feature) for the object query 9-21 (R=100). The input feature and an object box result 9-51 (referred to as a predicted detection box) are processed by using the region of interest pooling 9-114 to obtain a pooling feature 9-23 (referred to as an object image feature). Next, a complete domain encoding result 9-24 (referred to as a stitching feature) is acquired in combination with the region descriptor 9-22 and the pooling feature 9-23. Herein, the object query is taken as learnable information, and non-maximum suppression (NMS) is eliminated in the encoder 9-112 and the decoder 9-113. Moreover, the region descriptor 9-22 includes position and limited appearance information. The input text 9-3 (describing the image and referred to as sample text) is encoded by the pre-trained model 9-121 to obtain an encoding feature 9-31 (referred to as a text sample feature). Next, the linear layer 9-131 processes the domain encoding result 9-24; the linear layer 9-133 processes the encoding feature 9-31; and the two acquired processing results are taken as input of the attention module 9-132 to obtain the cross-contextualize representation 9-41 (referred to as an associated feature). Finally, the box head 9-141 predicts a boundary box of the region descriptor 9-22 to obtain the object box result 9-51 (R region proposals), so as to be configured for visual grounding and detection tasks. The objectness head 9-142 predicts the region descriptor 9-22 to obtain a score 9-52 (referred to as a first object score) unrelated to the task. The cross-contextualize representation 9-41 is predicted by using the relatedness head 9-143 to obtain a score 9-53 (referred to as a second object score) related to the task. A relatedness score 9-54 (referred to as a third object score) is acquired in combination with the score 9-53 and the score 9-52. The relatedness score 9-54 is further configured to be combined with the cross-contextualize representation 9-41, and is taken as an input of the association condition module 9-134, to output text 9-55 (where one dog and one cat are recumbent on a bed, which is referred to as a third object score).

The DETR is configured for modeling object detection as set prediction. A label allocation policy of bipartite matching is used, so that End 2 End can be implemented, reducing NMS post-processing. The anchor-DETR determines an object query based on the clustering result of the detection box, which can improve accuracy of the box proposal. In addition, a model convergence speed can be improved and training time can be shortened by using a one-layer decoding processing process.

FIG. 10 is a schematic diagram of a decoding structure provided by an embodiment of this application. As shown in FIG. 10, the decoding structure 10-1 includes one-layer processing (layer 1). An image feature 10-11 (referred to as an initial image feature) is taken as a value to be inputted into a cross-attention module 10-12; a position code 10-13 (referred to as an initial region feature) and an image feature 10-11 are taken as keys to be inputted into the cross-attention module 10-12. Decoder embedding 10-14 (referred to as a feature of an object query box), and learnable query 10-15 ((x⁽⁰⁾, y⁽⁰⁾, h⁽⁰⁾, w⁽⁰⁾), including a specified query object and a query object acquired by clustering the detection box labels, named as the object query box) are taken as query features to be inputted into the cross-attention module 10-12. Herein, an offset outputted by layer 1 (Δx, Δy, Δh, Δw) is configured to be superimposed with (x⁽⁰⁾, y⁽⁰⁾, h⁽⁰⁾, w⁽⁰⁾) to obtain a new object query (x⁽¹⁾, y⁽¹⁾, h⁽¹⁾, w⁽¹⁾). Specifically, (x⁽⁰⁾, y⁽⁰⁾) is taken as a position query; (h⁽⁰⁾, w⁽⁰⁾) is configured to adjust the cross-attention module 10-12.

The specified query object is used, the query object acquired by clustering the detection box labels is taken as the object query; and the number of layers of the decoder is set to one layer, so that a convergence speed of the model can be improved when richness of detecting a multi-scale object by the model is ensured, so that a training period of an even image is reduced.

The backbone of the model may be initialized by using a pre-trained parameter of an ImageNet, and the rest adopts random initialization. Herein, during model training, the convolution template parameter w and the bias parameter b of the neural network model are solved by using a stochastic gradient descent (SGD) method. In each iteration process, a prediction result error is calculated and back-propagated to the convolutional neural network model; a gradient is calculated; and a parameter of the convolutional neural network model is updated. In a training environment of eight graphics processing units (GPU), a learning rate of the SGD may be set to 0.02. A batch size may be set to 16 images; and there are two images for each GPU. In addition, parallel training may be performed in a hardware environment (for example, a GPU).

The architecture shown in FIG. 9 may be applied to a content understanding service related to an image. For example, the architecture may be applied to visual question answering, image description, object detection and locating, and image classification.

For example, FIG. 11 is a schematic diagram of vision application provided by an embodiment of this application. As shown in FIG. 11, in a visual question answering application 11-11, for an input image and input text 11-21, an output result (referred to as an image detection result) 11-31 can be acquired; for an input image and input text 11-22, an output result 11-32 can be acquired; for an input image and input text 11-23, an output result 11-33 can be acquired; and for an input image and input text 11-24, an output result 11-34 can be acquired.

In an image description application 11-12, for an input image and input text 11-25, an output result 11-35 can be acquired; for an input image and input text 11-26, an output result 11-36 can be acquired; for an input image and input text 11-27, an output result 11-37 can be acquired; and for an input image and input text 11-28, an output result 11-38 can be acquired.

In an object detection and locating application 11-13, for an input image and input text 11-29, an output result 11-39 can be acquired; for an input image and input text 11-210, an output result 11-310 can be acquired; for an input image and input text 11-211, an output result 11-311 can be acquired; and for an input image and input text 11-212, an output result 11-312 can be acquired.

In an image classification application 11-14, for an input image 11-41 and input text 11-213, an output result 11-313 can be acquired; for an input image 11-42 and input text 11-214, an output result 11-314 can be acquired; for an input image 11-43 and input text 11-215, an output result 11-315 can be acquired; and for an input image 11-44 and input text 11-216, an output result 11-316 can be acquired.

In a training process of a universal visual model, the anchor box is determined based on the clustering result of the detection box labels; and the number of decoding layers is reduced, so that a convergence speed can be accelerated, a training time length can be reduced, training consumption can be reduced, and accuracy of detection and locating task can be improved.

The following continues to describe a structure of the first image processing apparatus 455 provided by an embodiment of this application, that is implemented as a software module. In some embodiments, as shown in FIG. 4, the software module in the first image processing apparatus 455 stored in the first memory 450 may include:
a data collection module 4551, configured to acquire training data of a model to be trained, the model to be trained being a artificial neural network model to be trained, the model to be trained being configured to perform image processing, the training data including sample text, a sample image, and a sample label, and the sample label including detection box labels of the sample image;
a label clustering module 4552, configured to cluster the detection box labels to obtain N initial anchor box sizes, N being a positive integer;
an image prediction module 4553, configured to perform the following process to train the model to be trained: acquiring a text sample feature of the sample text, and detecting the sample image in combination with the N initial anchor box sizes and the text sample feature to obtain a sample detection result; and
a model training module 4554, configured to train the model to be trained based on a difference between the sample detection result and the sample label to obtain an image processing model, the image processing model being configured to acquire an image detection result based on an image and an image text prompt.

In one embodiment of this application, the label clustering module 4552 is further configured to cluster the detection box labels based on a size dimension to obtain M classes of clustering results, where M≥N, and M is an integer; acquire the M detection box sizes corresponding to the M classes of clustering results; collect statistics on a quantity of detection boxes of each detection box size from the detection box labels; select, from the M detection box sizes, the N detection box sizes with a largest quantity of detection boxes; and determine the N initial anchor box sizes based on the N detection box sizes.

In one embodiment of this application, the first image processing apparatus 455 further includes a size acquiring module 4555, configured to acquire L specified anchor box sizes different from the N initial anchor box sizes, L being a positive integer.

In one embodiment of this application, the image prediction module 4553 is further configured to detect the sample image in combination with the L specified anchor box sizes, the N initial anchor box sizes, and the text sample feature to obtain the sample detection result.

In one embodiment of this application, the image prediction module 4553 is further configured to perform region encoding on an initial image feature of the sample image to obtain an initial region feature; determine Q object query boxes in combination with the N initial anchor box sizes and P specified objects, P and Q being both positive integers; perform attention processing in combination with the initial region feature, the initial image feature, and the Q object query boxes to obtain an object region feature; and acquire the text sample feature of the sample text, and detect the sample image in combination with the object region feature and the text sample feature to obtain the sample detection result.

In one embodiment of this application, the image prediction module 4553 is further configured to determine a key feature, a value feature, and a query feature in combination with the initial region feature, the initial image feature, and the Q object query boxes; perform attention processing on the key feature, the value feature, and the query feature by using an object decoder of the model to be trained to obtain Q query box offsets; correspondingly superimpose the Q query box offsets onto the Q object query boxes to obtain Q object anchor boxes; and acquire features respectively corresponding to the Q object anchor boxes to obtain the object region feature.

In one embodiment of this application, the image prediction module 4553 is further configured to determine the key feature based on the initial region feature and the initial image feature; determine the value feature based on the initial image feature; and determine the query feature based on the Q object query boxes and specified content features respectively corresponding to the Q object query boxes.

In one embodiment of this application, the image prediction module 4553 is further configured to perform detection box prediction based on the object region feature to obtain a predicted detection box; perform attention processing on the object region feature and the text sample feature to obtain an associated feature; predict a first object score of the predicted detection box based on the object region feature, predict a second object score of the predicted detection box based on the associated feature, and obtain a third object score in combination with the first object score and the second object score; obtain a text prediction result in combination with the third object score and the associated feature; and determine the sample detection result based on the text prediction result.

In one embodiment of this application, the image prediction module 4553 is further configured to perform linear conversion on the object region feature to obtain an image linear feature; perform linear conversion on the text sample feature to obtain a text linear feature; perform attention processing on the image linear feature and the text linear feature to obtain a relatedness weight; and superimpose the relatedness weight and the image linear feature to obtain the associated feature.

In one embodiment of this application, the image prediction module 4553 is further configured to pool the initial image feature based on the predicted detection box to obtain an object image feature; acquire a stitching feature of the object image feature and the object region feature; and perform attention processing on the stitching feature and the text sample feature to obtain the associated feature.

In one embodiment of this application, the object query box includes the following information: an anchor point and an anchor box, the anchor point indicating a position point of the specified object in the sample image, and the anchor box indicating a region box size using the anchor point as a center.

The following continues to describe a structure of the second image processing apparatus 255 provided by an embodiment of this application, that is implemented as a software module. In some embodiments, as shown in FIG. 5, the software module in the second image processing apparatus 255 stored in the second memory 250 may include:
a request response module 2551, configured to acquire an image to be processed and an image text prompt in response to an image processing request; and
an image detection module 2552, configured to detect the image to be processed and the image text prompt by using an image processing model to obtain an image detection result, the image processing model being obtained by training with the image processing method provided by one embodiment of this application.

In one embodiment of this application, the image text prompt is prompt text of any one of the following image processing tasks: visual question answering, image description, object detection and locating, and image classification.

An embodiment of this application provides a computer program product, having a computer-executable instruction or a computer program, the computer-executable instruction or the computer program being stored in a computer-readable storage medium. A first processor of the first electronic device reads the computer-executable instruction or the computer program from the computer-readable storage medium, and the first processor executes the computer-executable instruction or the computer program to cause the first electronic device to execute the image processing model training method applied to the first electronic device according to one embodiment of this application; or a second processor of the second electronic device reads the computer-executable instruction or the computer program from the computer-readable storage medium, and the second processor executes the computer-executable instruction or the computer program to cause the second electronic device to execute the image processing method applied to the second electronic device according to one embodiment of this application.

An embodiment of this application provides a computer-readable storage medium, having a computer-executable instruction or a computer program stored therein, the computer-executable instruction or the computer program, when executed by a first processor, causing the first processor to execute the image processing model training method applied to the first electronic device provided by one embodiment of this application; or the computer-executable instruction or the computer program, when executed by a second processor, causing the second processor to execute the image processing method applied to the second electronic device provided by one embodiment of this application, for example, the image processing method shown in FIG. 6.

In some embodiments, the computer-readable storage medium may be a memory such as a FRAM, a ROM, a flash memory, a magnetic surface memory, an optical disc, or a CD-ROM, or may be various devices including one or any combination of the memories.

In some embodiments, the computer-executable instruction may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instruction may, but does not necessarily correspond to a file in a file system, and may be stored as a part of a file that saves another program or data, for example, stored in one or more scripts in a hyper text markup language (HTML) file, stored in a single file dedicated to a program in discussion, or stored in a plurality of collaborative files (for example, files that store one or more modules, subprograms, or code parts).

For example, the computer-executable instruction may be deployed to be executed on an electronic device (at this time, this electronic device is the model training device and the model application device), or to be executed on multiple electronic devices located at one location (at this time, the multiple electronic devices located at one location are the model training device and the model application device), or to be executed on multiple electronic devices distributed at multiple locations and interconnected through a communication network (at this time, the multiple electronic devices distributed at multiple locations and interconnected through a communication network are the model training device and the model application device).

In some embodiments of this application, relevant data, such as the image and the text are involved. When some embodiments of this application are applied to specific products or technologies, permission or consent of an information subject is required, and collection, use, and processing of relevant data need to comply with relevant laws and regulations, and standards. In this application, when implementation of an involved data crawling technical solution in the foregoing embodiment of this application is applied to a specific product or technology, relevant data collection, use, and processing processes are to comply with requirements of national laws and regulations, comply with a principle of legality, legitimacy, and necessity, not involve acquiring of a data type prohibited or restricted by the laws and regulations, and not hinder normal operation of an object website.

In conclusion, in one embodiment of this application, when the model to be trained configured to perform an image processing task is trained; the N initial anchor box sizes are determined according to a clustering result of the detection box labels; and the sample image is detected based on the N initial anchor box sizes to train the model to be trained. In the foregoing model training process, the N initial anchor box sizes are acquired by the detection box labels, so that a training direction is accurately controlled. Accordingly, a convergence speed of the model is increased and model training efficiency is improved. In addition, in a model training process, the number of decoding layers is further reduced. Therefore, the model training efficiency is improved.

The foregoing descriptions described above are merely some embodiments of this application, and this is not intended to limit the protection scope of this application. Any modification, equivalent replacement, or improvement made within the spirit and scope of this application shall fall within the protection scope of this application.

What is claimed is:

1. A training method, performed by a first electronic device, the method comprising:
acquiring training data, the training data comprising a sample text, a sample image, and a sample label, and the sample label comprising detection box labels of the sample image;
clustering the detection box labels to obtain N initial anchor box sizes, N being a positive integer;
acquiring a text sample feature of the sample text, and detecting the sample image in combination with the N initial anchor box sizes and the text sample feature to obtain a sample detection result; and
training a model to be trained based on a difference between the sample detection result and the sample label to obtain a trained image processing model, the image processing model being configured to acquire an image detection result based on an input image and an image text prompt.

2. The method according to claim 1, wherein the clustering the detection box labels to obtain N initial anchor box sizes comprises:
clustering the detection box labels based on a size dimension to obtain M classes of clustering results, M≥N, and M being an integer;
acquiring M detection box sizes corresponding to the M classes of clustering results; and
collecting statistics on a quantity of detection boxes corresponding to each of the detection box sizes from the detection box labels;
selecting N detection box sizes with a maximum quantity of the detection boxes from the M detection box sizes; and
determining the N initial anchor box sizes based on the N detection box sizes.

3. The method according to claim 1, wherein after the clustering the detection box labels to obtain N initial anchor box sizes, the method further comprises:
acquiring L specified anchor box sizes different from the N initial anchor box sizes, L being a positive integer; and
the detecting the sample image in combination with the N initial anchor box sizes and the text sample feature to obtain a sample detection result comprises:
detecting the sample image in combination with the L specified anchor box sizes, the N initial anchor box sizes, and the text sample feature to obtain the sample detection result.

4. The method according to claim 1, wherein the acquiring a text sample feature of the sample text, and detecting the sample image in combination with the N initial anchor box sizes and the text sample feature to obtain a sample detection result comprises:
performing region encoding on an initial image feature of the sample image to obtain an initial region feature;
determining Q object query boxes in combination with the N initial anchor box sizes and P specified objects, P and Q being both positive integers;
performing attention processing in combination with the initial region feature, the initial image feature, and the Q object query boxes to obtain an object region feature; and
acquiring the text sample feature of the sample text, and detecting the sample image in combination with the object region feature and the text sample feature to obtain the sample detection result.

5. The method according to claim 4, wherein the performing attention processing in combination with the initial region feature, the initial image feature, and the Q object query boxes to obtain an object region feature comprises:
determining a key feature, a value feature, and a query feature in combination with the initial region feature, the initial image feature, and the Q object query boxes;
performing attention processing on the key feature, the value feature, and the query feature by using an object decoder of the model to be trained to obtain Q query box offsets;
correspondingly superimposing the Q query box offsets onto the Q object query boxes to obtain Q object anchor boxes; and
acquiring features respectively corresponding to the Q object anchor boxes to obtain the object region feature.

6. The method according to claim 5, wherein the determining a key feature, a value feature, and a query feature in combination with the initial region feature, the initial image feature, and the Q object query boxes comprises:
determining the key feature based on the initial region feature and the initial image feature;
determining the value feature based on the initial image feature; and
determining the query feature based on the Q object query boxes and specified content features respectively corresponding to the Q object query boxes.

7. The method according to claim 4, wherein the detecting the sample image in combination with the object region feature and the text sample feature to obtain the sample detection result comprises:
performing detection box prediction based on the object region feature to obtain a predicted detection box;
performing attention processing on the object region feature and the text sample feature to obtain an associated feature;
predicting a first object score of the predicted detection box based on the object region feature, predicting a second object score of the predicted detection box based on the associated feature, and obtaining a third object score in combination with the first object score and the second object score;
obtaining a text prediction result in combination with the third object score and the associated feature; and
determining the sample detection result based on the text prediction result.

8. The method according to claim 7, wherein the performing attention processing on the object region feature and the text sample feature to obtain an associated feature comprises:
performing linear conversion on the object region feature to obtain an image linear feature;
performing linear conversion on the text sample feature to obtain a text linear feature;
performing attention processing on the image linear feature and the text linear feature to obtain a relatedness weight; and
superimposing the relatedness weight and the image linear feature to obtain the associated feature.

9. The method according to claim 7, wherein the performing attention processing on the object region feature and the text sample feature to obtain an associated feature comprises:
pooling the initial image feature based on the predicted detection box to obtain an object image feature;
acquiring a stitching feature of the object image feature and the object region feature; and
performing attention processing on the stitching feature and the text sample feature to obtain the associated feature.

10. The method according to claim 4, wherein the object query box comprises the following information: an anchor point and an anchor box, the anchor point indicating a position point of the specified object in the sample image, and the anchor box indicating a region box size using the anchor point as a center.

11. A non-transitory computer-readable storage medium, having a computer-executable instruction or a computer program stored therein, the computer-executable instruction or the computer program, when being configured to be executed by a first processor, causing the first processor to implement:
acquiring training data of a model to be trained, the training data comprising a sample text, a sample image, and a sample label, and the sample label comprising detection box labels of the sample image;
clustering the detection box labels to obtain N initial anchor box sizes, N being a positive integer;
acquiring a text sample feature of the sample text, and detecting the sample image in combination with the N initial anchor box sizes and the text sample feature to obtain a sample detection result; and
training the model to be trained based on a difference between the sample detection result and the sample label to obtain a trained image processing model, the image processing model being configured to acquire an image detection result based on an input image and an image text prompt.

12. The storage medium according to claim 11, wherein the clustering the detection box labels to obtain N initial anchor box sizes comprises:
clustering the detection box labels based on a size dimension to obtain M classes of clustering results, M≥N, and M being an integer;
acquiring M detection box sizes corresponding to the M classes of clustering results; and
collecting statistics on a quantity of detection boxes corresponding to each of the detection box sizes from the detection box labels;
selecting N detection box sizes with a maximum quantity of the detection boxes from the M detection box sizes; and
determining the N initial anchor box sizes based on the N detection box sizes.

13. A first electronic device for model training, the first electronic device comprising:
a first memory, configured to store a computer-executable instruction or a computer program; and
a first processor, configured, when executing the computer-executable instruction or the computer program stored in the first memory, to implement:
acquiring training data of a model to be trained, the training data comprising a sample text, a sample image, and a sample label, and the sample label comprising detection box labels of the sample image;
clustering the detection box labels to obtain N initial anchor box sizes, N being a positive integer;
acquiring a text sample feature of the sample text, and detecting the sample image in combination with the N initial anchor box sizes and the text sample feature to obtain a sample detection result; and
training the model to be trained based on a difference between the sample detection result and the sample label to obtain a trained image processing model, the image processing model being configured to acquire an image detection result based on an input image and an image text prompt.

14. The electronic device according to claim 13, wherein the clustering the detection box labels to obtain N initial anchor box sizes comprises:
clustering the detection box labels based on a size dimension to obtain M classes of clustering results, M≥N, and M being an integer;
acquiring M detection box sizes corresponding to the M classes of clustering results; and
collecting statistics on a quantity of detection boxes corresponding to each of the detection box sizes from the detection box labels;
selecting N detection box sizes with a maximum quantity of the detection boxes from the M detection box sizes; and
determining the N initial anchor box sizes based on the N detection box sizes.

15. The electronic device according to claim 13, wherein after the clustering the detection box labels to obtain N initial anchor box sizes, the first processor is further configured to perform:
acquiring L specified anchor box sizes different from the N initial anchor box sizes, L being a positive integer; and
the detecting the sample image in combination with the N initial anchor box sizes and the text sample feature to obtain a sample detection result comprises:
detecting the sample image in combination with the L specified anchor box sizes, the N initial anchor box sizes, and the text sample feature to obtain the sample detection result.

16. The electronic device according to claim 13, wherein the acquiring a text sample feature of the sample text, and detecting the sample image in combination with the N initial anchor box sizes and the text sample feature to obtain a sample detection result comprises:
performing region encoding on an initial image feature of the sample image to obtain an initial region feature;
determining Q object query boxes in combination with the N initial anchor box sizes and P specified objects, P and Q being both positive integers;
performing attention processing in combination with the initial region feature, the initial image feature, and the Q object query boxes to obtain an object region feature; and
acquiring the text sample feature of the sample text, and detecting the sample image in combination with the object region feature and the text sample feature to obtain the sample detection result.

17. The electronic device according to claim 16, wherein the performing attention processing in combination with the initial region feature, the initial image feature, and the Q object query boxes to obtain an object region feature comprises:
determining a key feature, a value feature, and a query feature in combination with the initial region feature, the initial image feature, and the Q object query boxes;
performing attention processing on the key feature, the value feature, and the query feature by using an object decoder of the model to be trained to obtain Q query box offsets;
correspondingly superimposing the Q query box offsets onto the Q object query boxes to obtain Q object anchor boxes; and
acquiring features respectively corresponding to the Q object anchor boxes to obtain the object region feature.

18. The electronic device according to claim 17, wherein the determining a key feature, a value feature, and a query feature in combination with the initial region feature, the initial image feature, and the Q object query boxes comprises:
determining the key feature based on the initial region feature and the initial image feature;
determining the value feature based on the initial image feature; and
determining the query feature based on the Q object query boxes and specified content features respectively corresponding to the Q object query boxes.

19. The electronic device according to claim 16, wherein the detecting the sample image in combination with the object region feature and the text sample feature to obtain the sample detection result comprises:
performing detection box prediction based on the object region feature to obtain a predicted detection box;
performing attention processing on the object region feature and the text sample feature to obtain an associated feature;
predicting a first object score of the predicted detection box based on the object region feature, predicting a second object score of the predicted detection box based on the associated feature, and obtaining a third object score in combination with the first object score and the second object score;
obtaining a text prediction result in combination with the third object score and the associated feature; and
determining the sample detection result based on the text prediction result.

20. The electronic device according to claim 19, wherein the performing attention processing on the object region feature and the text sample feature to obtain an associated feature comprises:
performing linear conversion on the object region feature to obtain an image linear feature;
performing linear conversion on the text sample feature to obtain a text linear feature;
performing attention processing on the image linear feature and the text linear feature to obtain a relatedness weight; and
superimposing the relatedness weight and the image linear feature to obtain the associated feature.
